(19) United States
(12) Patent Application Publication
(10) Pub. No.: US 2014/0108095 A1
(43) Pub. Date: Apr. 17, 2014

(54) SYSTEM AND METHOD FOR GENERATING AND PROVIDING CUSTOMIZED SURVEY QUESTIONNAIRES

(71) Applicant: IPerceptions Inc., Montreal (CA)

(72) Inventors: Pierre TETREAULT, Granby (CA); Joshua ZINLER, Montreal (CA); Martin ROY, Drummondville (CA)

(73) Assignee: IPerceptions Inc., Montreal (CA)

(21) Appl. No.: 14/053,912

(22) Filed: Oct. 15, 2013

Related U.S. Application Data
(60) Provisional application No. 61/714,148, filed on Oct. 15, 2012.
(60) Provisional application No. 61/829,458, filed on May 31, 2013.

(51) Int. Cl. G06Q 30/02

(52) U.S. Cl. CPC G06Q 30/0203
USPC 705/7.32

(57) ABSTRACT

The present disclosure relates to a method and a user device for generating and providing customized survey questionnaires. The method and user device monitor events occurring on the user device and generate behavioral data accordingly. Upon detection of fulfillment of a survey trigger condition, the method and user device generate a customized survey questionnaire including a question either selected or generated based on the generated behavioral data. The customized survey questionnaire is generated using survey customization data. The method and user device provide to a user the customized survey questionnaire, collect a response to the question from the user thereby generating survey participation data, and transmit the survey participation data to a survey server.

### FIELD OF THE INVENTION

The present disclosure relates to the field of web surveys, and more particularly to customized questionnaire building in relation with web surveys.

### BACKGROUND

Nowadays, corporations need to understand their patrons, and more particularly to identify the potential intent of their patrons in relation with their brand, services and products, and what their patrons like and dislike in the products and services they offer them. Inaccurate identification of the patrons and their opinions may result in great losses, for instance loss of sales, inaccurate responses to the needs of the patrons, loss of fidelity of the patrons to the brand, etc. Accordingly, any tool capable of increasing the corporate understanding of their patrons, and validity level associable to this knowledge, has important value for corporations.

The same applies to tools used to interact with these patrons. The more efficient they are, the higher the chances to monetize any interaction with these patrons. Accordingly, evaluation tools are needed to establish the efficiency of the tools used to interact with the patrons, including evaluation tools used to evaluate websites.

Currently, the most commonly used tools to acquire information on website visitors, i.e. understanding the level of success of a website consist in the following: (1) web analytics tools such as Google Analytics and (2) survey tools. Another available tool consists in (3) session recording tools, also known as session replay processes. While the first type of tools comprises tools to follow the actions performed by visitors of a website (therefore responds to the WHAT question), it fails to provide tools to understand the reasons for a visitors not completing a task (the WHY question) such as not being able to complete a purchase. The second type of tools, while being effective at understanding the reasons for a visitor not having completed the task, lacks a capacity to provide only useful questions to the survey respondent, in order to prevent the respondent to provide ill-based responses related to not visited webpages for example. The third type of tools, as efficient as it is to understand the actions of a visitor, remains, as the first type of tools, based on actions performed by visitors of the website.

Similar problems arise with general public devices such as televisions and cars. There is no available solution to collect valuable information on why a customer uses a function while not another, and to collect information on the level of satisfaction of the customer.

Therefore, none of the previously mentioned available solutions provide a way to improve a questionnaire used in a survey and to increase a value of responses provided by survey respondents.

### SUMMARY

In an aspect, the present disclosure relates to a method for generating and providing customized survey questionnaires on a processor-based user device. For doing so, the method monitors, by means of a behavioral monitoring component on the user device, events occurring on the user device and generates behavioral data accordingly. The method also detects, by means of the behavioral monitoring component, fulfillment of a survey trigger condition. Upon detection of the survey trigger condition fulfillment, the method generates, by means of a survey conduct component, a customized survey questionnaire including a question either selected or generated based on the behavioral data. The method also provides, by means of the survey conduct component, the customized survey questionnaire to a user of the user device. The method further collects, by means of the survey conduct component, a response to the question from the user, thereby generating survey participation data. Then, the method transmits, by means of the survey conduct component, the survey participation data to a survey server.

In another aspect, the present disclosure relates to a user device for generating and providing customized survey questionnaires. The user device comprises a processor, a communication interface and a memory. The communication interface is adapted for communicating with a server through a communication network. The memory stores data and instructions which, when executed, generate a behavioral monitoring component and a survey conduct component. The behavioral monitoring component monitors events occurring on the user device and generates behavioral data accordingly. The behavioral monitoring component further detects fulfillment of a survey trigger condition. The survey conduct component generates a customized survey questionnaire, the customized survey questionnaire including a question either selected or generated based on the generated behavioral data using the survey customization data. The survey conduct component also provides to a user of the user device the customized survey questionnaire. The survey conduct component further collects a response to the question from the user thereby generating survey participation data. The survey conduct component also transmits the survey participation data to a survey server.

### BRIEF DESCRIPTION OF THE DRAWINGS

In the appended drawings:

FIG. 1 is an exemplary schematic representation of an environment in which the present method is performed;

FIG. 2a is an exemplary schematic representation of the user device illustrated on FIG. 1;

FIG. 2b is an exemplary schematic representation of the runtime environment provided by a web browser component hosted by the user device illustrated on FIG. 1 and FIG. 2a;

FIG. 2c is an exemplary schematic representation of the web client components of FIG. 2b;

FIG. 3 is an exemplary schematic representation of the web server illustrated on FIG. 1;

FIG. 4 is an exemplary schematic representation of the survey server illustrated on FIG. 1;

FIG. 5 is a signal flow exchange between the components illustrated on FIG. 1;

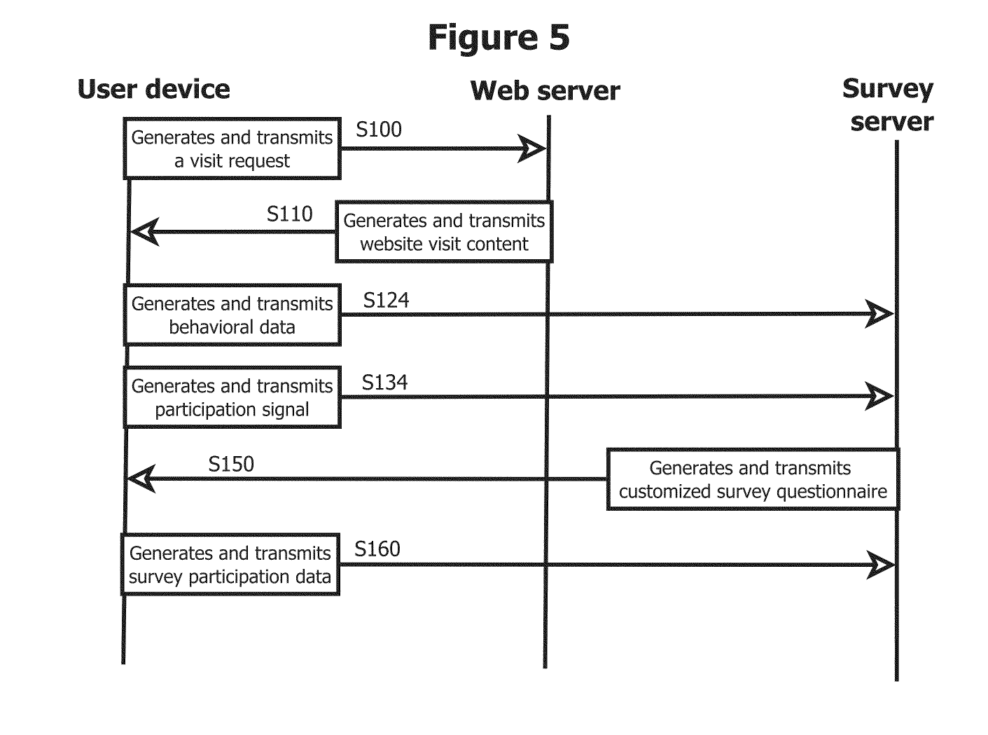

FIG. 6 is a flow chart of the method performed by the user device;

FIG. 7 is flow chart completing the flow chart of the method of FIG. 6, performed by the user device; and

FIG. 8 is an alternate flow chart completing the flow chart of the method of FIG. 6, performed by the user device.

### DETAILED DESCRIPTION

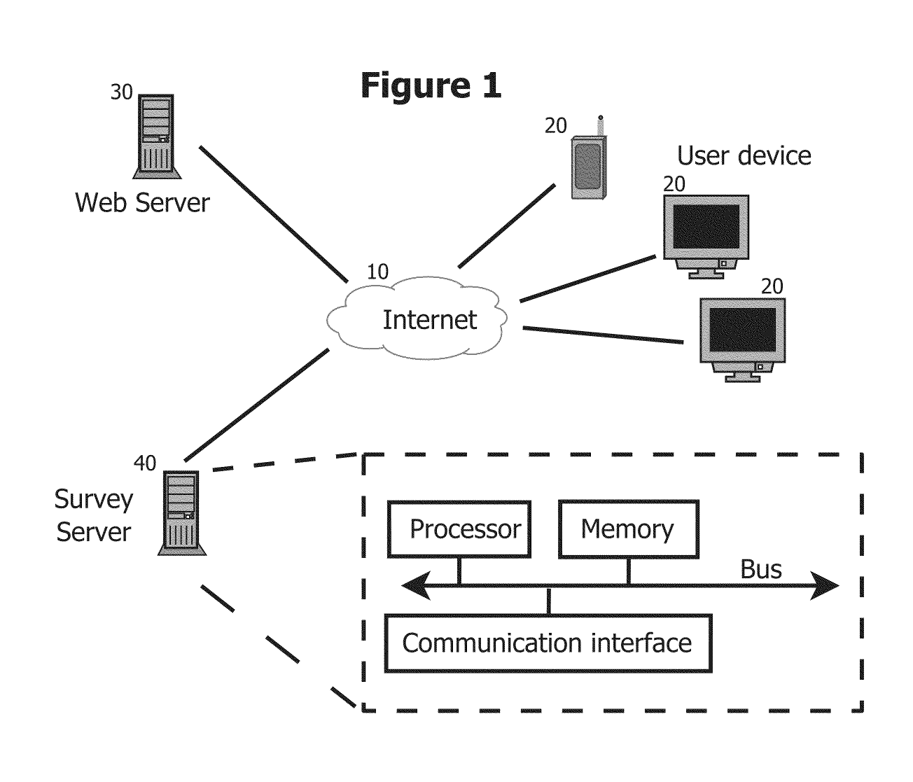

Reference is now made to FIG. 1, which depicts an environment in which the present method and user device generate customized survey questionnaires. The user device 20 is may be any type of processor-based devices capable of hosting a web client component. The user device 20 is adapted for communicating with, a web server 30 and a survey server 40 over a network, such as the Internet 10, or a plurality of networks linked or bridged electronically, optically or wirelessly and permitting communication there between. The skilled reader will understand that the environment depicted in FIG. 1 is a simplified representation of some of the components present in such an environment, and other devices such as web analytic server and a tag management server could be included.

There are two types of user devices 20: general-purpose user devices and specific-purpose user devices. Generic-purpose user devices include user devices having a broad set of possible utilities and functions determined mostly based on applications installed by the user on the user device. Exemplary illustrations of generic-purpose user devices comprise desktop computers, laptop computers, tablets such as iPad™ by Apple, smartphones and personal digital assistants (PDAs), which all share the characteristics of being able to host a web client, such as a web browser, and to communicate with remote devices over a network. Specific-purpose user devices are, on the other hand, intended to cover devices having a pre-set list of functions and settings. The uses of the devices are mostly kept within the pre-set functions. Exemplary illustrations are user devices which share similar processor-based architecture, a network communication interface and a specific purpose, such as smart televisions and smart appliances for instance.

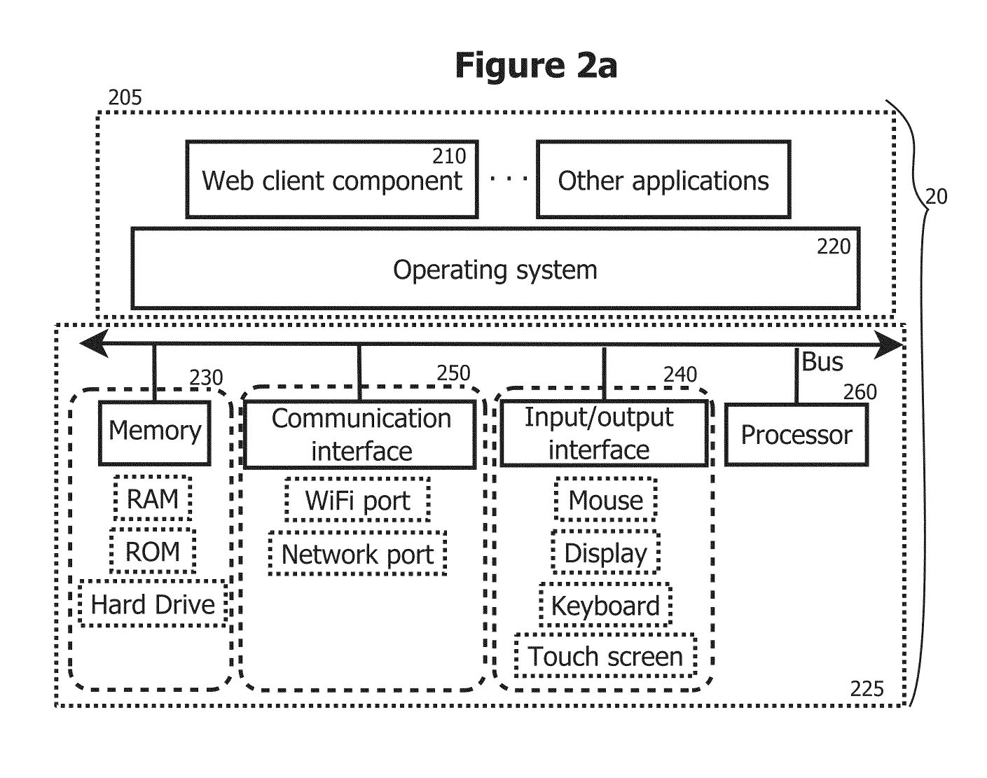

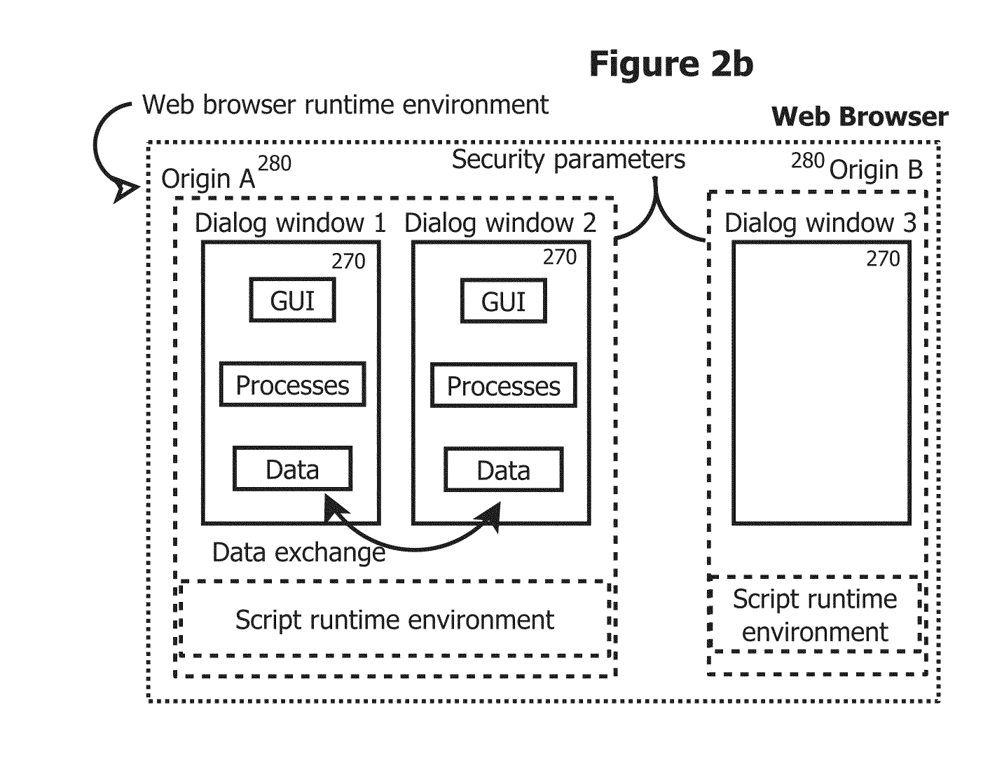

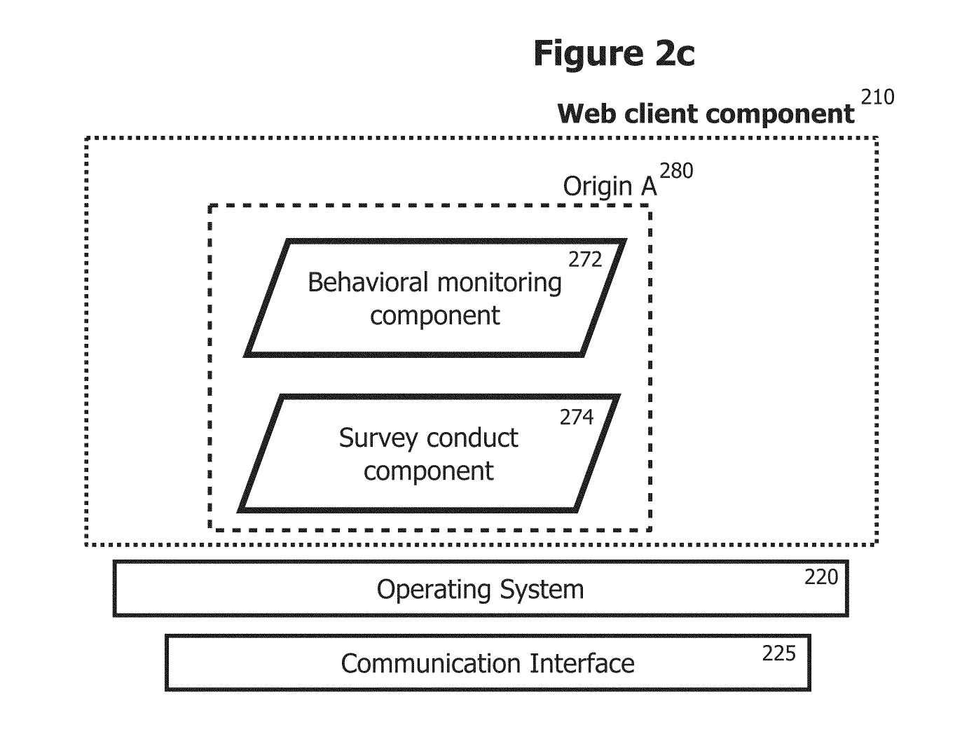

Reference is now made to FIG. 2a, which illustrates an example of a generic-purpose user device 20 hosting a web client component 210. The user device 20 comprises hardware components 225 and software components 205 resulting from codes stored on memory 230 and executed by a processor 260. A web client component 210 is hosted by the user device 20. The web client component 210 may either be originally integrated with the user device 20, or the web client component 210 may be installed later. The web client 210 may consist in a web browser such as Microsoft Internet Explorer™, Google Chrome™, Apple Safari™ or Mozilla Firefox™ to list a few. Other web client components 210, usually web client components customized for specific tasks and/or processes and designed to communicate with specific servers, may be available such as those developed under the Adobe Integrated Runtime (AIR) or Windows Runtime (WinRT) environment.

The user device 20 comprises the following hardware components 225: the processor 260, the memory 230, an input/output interface 240 and a communication interface 250 necessary to communicate over a network. The software components 205 include an operating system 220 and the web client component 210. The web client component 210 interacts with the hardware components 225 in a functional manner, to access the memory 230 for reading and writing data, to communicate with other devices and servers, display information and receive input from the user for instance trough keyboard and mouse controls, etc.

Reference is now made concurrently to FIGS. 2a and 2b. The web client component 210 is a web browser designed to access websites, by exchanging data packets with web servers, and downloading and processing web content, such as HTML documents, provided by the web servers. The web browser provides access to webpages to a user of the device. The web browser is further adapted to provide the necessary runtime environment for processes to be performed, when HTML documents feature include embedded instructions (also called scripts). The web browser is also adapted to apply security policies restrictions, in relation with the provided runtime environment. The security policies for instance limit accessibility to information and processes according to origin identification, therefore isolating data relative to a dialog window with respect to one origin from another dialog window (and associated processes) with respect to another origin. The web browser is further designed to store in the user device memory codes to be used according to runtime environment policies, such as scripts and cookies. In relation with the user interface, the web browser provides one or more dialog windows 270, according to which processes are performed in relation with domain session and/or origin identification 280. The dialog windows 270 may or may not be part of the same browsing session, based on the domain they are communicating with. Origin identification 280 establishes a security parameter, isolating information, logical components and resulting processes according to one browsing session with respect to another browsing session, based on the origin identification rather than on graphical presentation in the web browser interface.

The web browser is a computer program comprising instructions executed by the processor 260. During the execution of the web browser's instructions, the processor 260 may need to access the memory 230, use the communication interface 250 to send and receive data packets, and rely on the input/output interface 240 to obtain inputs from the user, display web pages on the display, etc. Upon visit of a website, the content received from the corresponding web server to generate and display the webpages may include: HTML documents, Content Style Sheets capable of providing display layouts and rules used to determine the layout for generating the webpage to be displayed, and discrete web content to be integrated in the displayed webpage independently from the webpage structure provided by the HTML document and the Content Style Sheet. Examples of discrete web contents include text elements, images, sounds, videos and animations to list a few. According to this definition, website visit content includes at least one HTML document, and may include a Content Style Sheet and discrete web contents to be integrated in the webpage(s) to be displayed.

Alternative web clients specifically designed either for general-purpose user devices or for specific-purpose user devices, may feature different characteristics. However, they still include communication capabilities, provide a runtime environment for generating logical component completing processes, have a memory for storing data, and have display and input capabilities for conducting a survey process.

Reference is now made to FIG. 2c, which schematically represent the functional structure of the web client component 210. The web client component 210 includes a behavioral monitoring component 272 and a survey conduct component 274 that are generated upon processing of instructions by the web client runtime environment. The behavioral monitoring component 272 and the survey conduct component 274 perform their operations within the security parameters set based on the origin associated therewith.

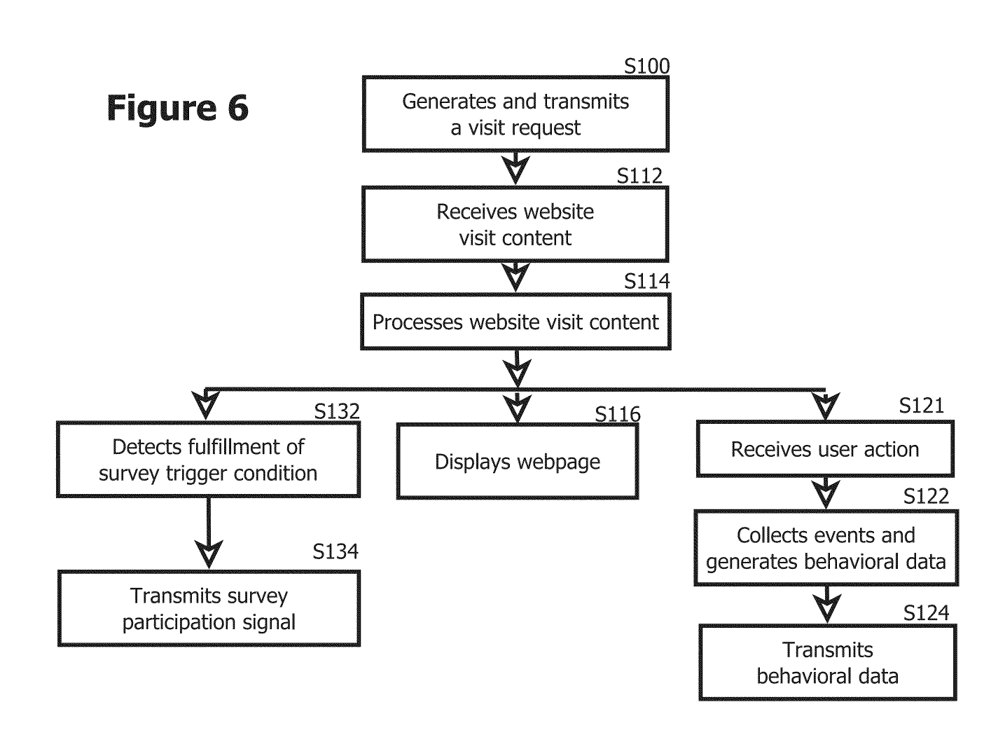

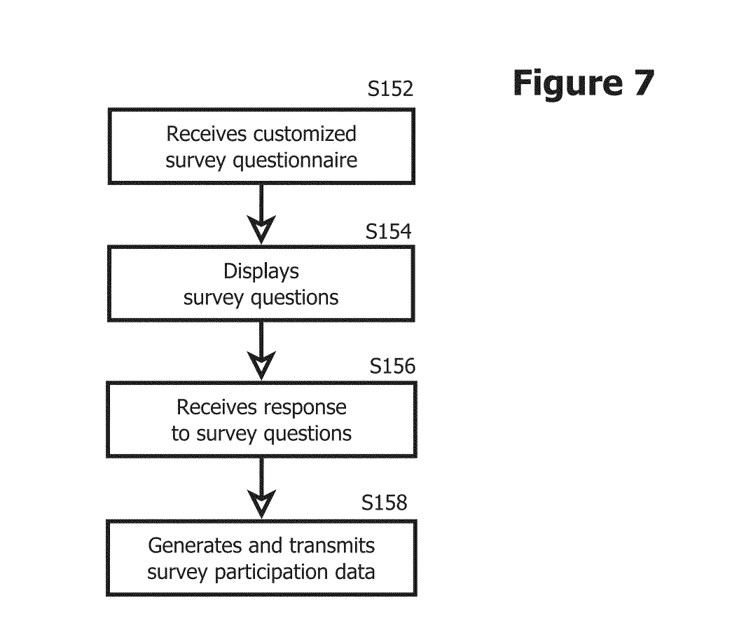

Reference is now concurrently made to FIGS. 1, 2a, 2c, 6 and 7. At step S100, the web client component 210 of the user device 20 generates and transmits a website visit request, through the communication interface 250, to the web server 30. The visit request is generally characterized in an URL transmitted to the web server 30 (or a series of web servers) responsible to respond to visit requests relative to the website. At step S112, the web client component 210 of the user device 20 receives from the web server 30 a web content in response to the visit request. The web content includes a HTML document, and may optionally contain content style sheet (CSS) and discrete web content. At step S114, the user device 20, according to the runtime environment provided by the web client component 210, processes the HTML document and the optional additional data transmitted by the web server 30. Processing the web content includes generating a webpage to be afterward displayed, and processing instructions (e.g. scripts in a high-level language such as Java Scripts) optionally embedded in the HTML document or other web content.

In an alternative embodiment, a tag manager server (not illustrated in the Figures) may further be used. In this case, processing of the embedded instructions triggers communication with the tag manager server, and the latter sending additional instructions to the user device 20. The transmitted additional instructions are afterwards executed by the user device 20 as if they were embedded in the web content transmitted by the web server 30. Accordingly, instead of integrating a plurality of scripts in the web content, a website owner may use this solution to communicate all of them using a single web content embedded script. The result is similar to the case where the script is embedded in the web content.

At step S116, the web client component 210 displays, for instance on a screen, the webpage resulting from the processing of the web content. At step S122, a behavioral monitoring component 272 on the user device 20, generated according to the processing of instructions embedded in an HTML document and executed according to the web client runtime environment, initiates a behavioral monitoring and transmission process. According to a first alternative, the process consists in verifying the presence of a cookie stored in the user device memory and associated with the website. If such a cookie exists, the process consists in processing the cookie data to determine if the cookie data are indicative of events that have occurred on the user device with respect to the website during a previous ongoing browsing session during which the user device has been used to visit the website. Furthermore, the process consists in identifying the events which occurred during the previous visit of the website. At step S124, the behavioral monitoring component 272 monitors events occurring on the user device in respect to the origin associated with the website visit. The behavioral monitoring component 272 further generates behavioral data indicative of monitored events occurring on the user device 20 during the web browsing session. When the event triggers a new visit request, or more specifically a request to a new webpage, the process includes a return to step S100 whereby the new request is transmitted to the web server 30.

In available alternatives, the nature of the generated behavioral data may vary. According to one alternative, the generated behavioral data is indicative of only a predetermined set of events with respect to the visit of the website. According to another alternative, the behavioral data may also include indications on the visited webpages. According to still another alternative, the behavioral data may also include indication of the time at which the events occurred. According to yet another alternative, the behavioral data may also include event parameters when applicable, for example form filled data. Accordingly, the nature of the events used to generate behavioral data, as well as the additional information used in relation with these events, depend on specific objectives, performance, amount of data and scalability, available resources and other technical questions. Therefore, within the scope of the present disclosure, a broad variety of information may take part of the generated behavioral data.

At step S132, the behavioral monitoring component 272 detects that a survey participation trigger condition has been fulfilled. The trigger condition may take many forms, from the detection of an event during the current ongoing browsing session such as clicking on a particular hyperlink, to environmental factors such as the time period between the occurrence of a specific event identified in the collected behavioral data and the time of the current ongoing browsing session. Another example is the repetition of the same specific event identified in the collected behavioral data and detected during the current ongoing browsing session. The trigger conditions that can be defined for triggering the conduct of a survey are numerous, and dependent on the objectives of the person ordering or conducting the survey. In some embodiments, a combination of conditions may also be used to trigger the conduct of a survey. The above examples have been provided only to enlighten the fact that every detectable event or comparison of detectable events may be used as trigger conditions.

At step S134, the customizing questionnaire engine component 276 generates a customized survey questionnaire based on the collected behavioral data. In one alternative, the behavioral data are kept in Random-Access Memory (RAM) or any other memory that permits fast access by the processor 260. In another alternative, the behavioral data is written in a memory component providing slower access, such as a hard drive in the case of personal computers. Accordingly, the behavioral data may be stored as a cookie associated with the origin associated with the website visit.

The customizing questionnaire engine component 276 is designed to generate, based on identified events in the behavioral data, a customized survey questionnaire including one or more questions based on the identified event. Accordingly, the customizing questionnaire engine component 276 is designed to perform at least one of: selecting a survey question among a plurality of survey questions from a survey question database based on the behavioral data, or generating a survey question based on the behavioral data.

Alternatively and/or concurrently, the customizing questionnaire engine component 276 is designed to receive in an asynchronous manner a survey question set and survey parameters from the survey server 40, and to store the received survey question set and survey parameters. Accordingly, when the survey trigger condition is fulfilled, the user device 20 already has in memory the information needed to generate the customized survey questionnaire. Using this information, the customizing questionnaire engine component 276, according to a specific algorithm, selects one or more of the questions available in the survey question set to be included in the customized survey questionnaire.

Alternatively and/or concurrently, the customized survey conduct component 276 exchanges data with the survey server 40, following the fulfilment of the survey trigger condition. The data exchange consists in comparing the version of the survey question sets and the survey parameters between the one on the user device 20 and the one on the survey server 40. If a difference exists, the survey server 40 transmits the current survey question sets and survey parameters to the customizing questionnaire engine component 276 of the user device 20. Therefore, surveys are always conducted according to the latest questions and parameters.

In still another alternative embodiment, no survey question sets and survey parameters are stored on the user device 20. When the survey trigger condition is fulfilled, the customizing questionnaire engine component 276 signals the survey server 40, and receives in response a survey question set and survey parameters to use to generate the customized survey questionnaire.

In yet another alternative embodiment, the nature of the data used by the customizing questionnaire engine component 276 consists in sentence layouts and survey parameters. The customizing questionnaire engine component 276 combines the sentence layouts and information extracted from the collected behavioral data, according to survey parameters, to generate original questions to be included in the customized survey questionnaire. As described above, the sentence layouts and the survey parameters may be the object of different solutions to control the time they are communicated to the customizing questionnaire engine component 276 of the user device 20.

At step S154, the survey conduct component 274 provides the customized survey questionnaire to the user of the user device 20. In the present context, the customized survey questionnaire is displayed in a window of the web client component 210 20. In one alternative, the customized survey questionnaire comprises many questions selected based on the events identified from the behavioral data. For instance, the customized survey questionnaire will include a question on the purchase process and associated webpages when the behavioral data indicates that the user has performed a purchase during its website visit or a previous visit for instance. Another example of questions is one specific webpage displayed data based on the behavioral data indicating that this page has been visited. In addition, one alternative consists in including a set of standard questions in the customized survey questionnaire. Therefore, both generic topics and specific topics may be covered by the customized survey questionnaire. These are only examples of possible customization; the breadth of the customization is only limited by the events that can be monitored and the survey objectives. Thus the format of the customized survey questionnaire is as broad as with any other web survey. Survey questions in one alternative may be provided in a sequence of windows, wherein only one or two questions are provided at a time; while in another alternative the questions are assembled in a single user interface and provided together. In the case of the sequence of windows, once all questions contained in the window are answered, the current window in replaced with a new one, or refreshed with new question(s). The nature and presentation of the responses may vary; namely ratings, ordering of elements, selection of an element among a series of available elements, graphic controls to provide responses such as sliding control on a graduate ruler, and open-ended questions wherein the survey participant provides a response in his own words in a free-text format, constitute available solutions. A mix of these solutions may also be used to receive responses from a survey participant. The selection of the form is only a question of context, all of these solutions being known and part of the state or the art.

At step S156, the survey conduct component 274 receives responses to the survey question(s) from the survey participant. The number of questions may be limited to one, or may include responses to a series of questions provided according to one or more of the above-discussed formats. At step S160, the survey conduct component 274 transmits data indicative of the responses received in relation with one of the survey questionnaires, namely survey participation data, to the survey server 40.

According to another alternative embodiment, the survey participation trigger condition is fulfilled when the website visit window is closed, and the survey conduct component 274 forces the window used by the behavioral monitoring component 272 to get in front of any other window. Upon reception of the survey responses from the survey participant, survey participation data is transmitted to the survey server 40, followed with the window used by the behavioral monitoring component 272 being closed, therefore ending the browsing session.

Throughout the above description, the expression “customized survey questionnaire” refers to a questionnaire built based on events monitored before the beginning of the conduct of the survey participation on the user device. Customization of the survey questionnaire after the beginning of the conduct of the survey participation is not considered to be a customized survey questionnaire, since it is not already customized when transmitted to the user device. The customization of a survey questionnaire based on responses provided by a survey participant in one or more questions to the same survey questionnaire is known as a skip-logic process, and rely solely on the memory and goodwill of the survey participant. These concepts and processes are different and are generally handled separately, while it is possible to combine them.

Even though processes have been described, in relation with the above described alternatives, as resulting from the processing of web-content embedded instructions according to the web-client runtime environment; in some alternative, the initial web-content embedded instructions may generate a communication portal component on the user device 20 for controlling further communication between the user device 20 and the survey server 40. According to that communication portal component, once instructions provided by a first script are executed according to the web client runtime environment, communication exchanges occur between the survey server 40 and the user device 20 (under control of the communication portal component). Parameters, data, signals, and scripts (including additional instructions) may be communicated to the user device 20 via these communication exchanges. Accordingly, already running processes and running components may take into account the newly communicated data (e.g. a customized survey questionnaire), and new logical components may be generated when these additional instructions are executed according to the web client runtime environment. These exchanges and these initiations of new components and processes are typically invisible to the user of the user device 20. Everything is performed without intervention and/or knowledge of the user of the user device 20.

The above described steps have been provided as distinct steps in a non-limiting order. Some steps, even though expressed as distinct processes, may take place simultaneously, or may participate in the same signal transmission for instance. Accordingly, steps should be evaluated as a process definition, regardless if discrete processes are performed at the same time, together or through the same component for instance.

The specific-purpose user device 20 comprises a web client component 210 or similar component, providing networking communication capability and runtime environment. The specific-purpose user device 20 comprises similar components as the generic-purpose user device 20 of FIG. 2a; including an operating system 220 that can be specifically designed for the user device activities, coded in Java™ for instance. The user device 20 comprises a memory 230, a communication interface 250 (Wi-Fi or Bluetooth™ connectivity for example), an input and output interface 240 (I/O ports such as HDMI and USB ports for example), a processor 260, and specific-purpose hardware components (motors, digital decoders, indicators, heat elements, etc.) not shown. To control the specific-purpose hardware components, the user device 20 includes specific-purpose application components and survey conduct logic components. In the present case, depending on the specific-purpose user device, and more specifically the specific purpose itself, herein listed discrete components may be assembled into a single component. For instance, in the case of a smart television, the specific-purpose component that is the screen also takes part in the input and output interface 240.

Throughout the following description, a smart television will be used for description purposes. Nevertheless, a variety of devices may be included when referring to “specific-purpose user device”, including smart appliances, house automation components and systems, on-car control boards, etc.

Depending on the specific-purpose user device considered, the set up process, the environmental variables of importance prior to performing the present method, and the trigger condition to conduct a survey differ. Nevertheless, with any of these specific-purpose user devices, the method and system, when considered only in relation with participating in the specific objective of conducting a survey, are similar.

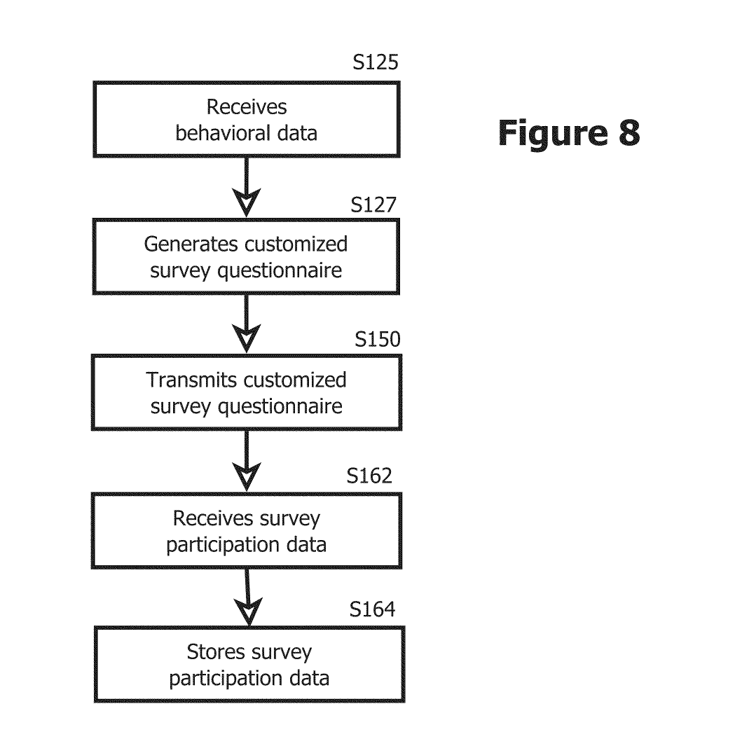

Reference is now made to FIG. 8. Beforehand, usually when the specific-purpose user device 20 is initially set up, the user configures the devices 20′. That configuration may include to set up communication with a home Wi-Fi, or/and with other devices like a smartphone. During the setup process, data are recorded on the device memory 230 such as date and time of set up.

At step S122, the behavioral monitoring component 272 monitors events occurring on the user device. The variety of monitored events include powering on and off the device 20, using one or more functions or the user device 20, registering the device for warranty through the user device 20 itself, using specific applications and functions, installing new applications on the user device 20, etc. Accordingly, a behavioral file is continuously updated along with monitoring of new events. The format of the storage of behavioral data may vary from a lightweight database, a text file, a specific-format file like an XML file, etc. That file or database is stored on memory 230 of the user device 20.

At step S132, the behavioral monitoring component 272 of the user device 20 detects that a survey participation trigger condition has been fulfilled. The trigger condition may also take many forms. Examples of available trigger conditions includes a time period since the setup of the user device 20, a minimum number of uses of the user device 20 or functions, a predetermined state, installation of a new application, reception of a signal from a remote device such a web server to list a few. In some cases, the trigger condition will be determined based on a combination of discrete conditions as the one listed above. In some case, like a car, some discrete conditions part of the trigger conditions will be determined based on security reasons, for instance triggering a survey conduct on a car only after the car is turned off.

At step S134, the survey conduct component 274 of the user device generates a customized survey questionnaire based on the behavioral data present in the behavioral file. Participating data used to generate a customized survey questionnaire may be extracted from a survey customization database, what may include pre-built questions and parameters.

The customizing questionnaire engine component is designed to generate, based on identified events in the behavioral data, a customized survey questionnaire including one or more questions based on the identified event. Accordingly, the customizing questionnaire engine component is designed to perform at least one of selecting a survey question among a plurality of survey questions from a survey question database based on the behavioral data, or generating a survey question based on the behavioral data.

At step S154, the survey conduct component 274 provides the customized survey questionnaire to the user of the user device 20. According to the available solutions to display survey questions and to receive survey responses from the user, the physical elements participating in conducting the survey participation will vary. For instance, for a smart television, the survey questions will be displays directly on the screen of the device 20. In the case of a smart appliance, since the display capabilities and input capabilities could be limited, it is possible that the appliance will connect through Bluetooth™ or through a specific communication port and a TCP/IP protocol for instance with a user device such as a smartphone or a computer, and transmits the questionnaire in a web format (a HTML document) to the connected device. When the user provide responses to the questions, the responses will be transmitted back to the user device 20.

Accordingly, at step S156, the survey conduct component 274 of the user device 20 receives responses to the survey question(s) from the survey participant; these responses being either provided directly on the user device 20 through available input capabilities, or via a remotely connected device under control of the user. The number of questions may be limited to one, or may include responses to a series of questions.

At step S158, the survey conduct component 274 of the user device 20 transmits data indicative of the responses receives in relation with of the survey questionnaire, namely survey participation data, to a survey server 40 adapted to receives the survey participation in association with identification of the user device 20, to store the survey participation data, and to analyse the survey participation data according to different perspectives, including need for assistance, statistical survey of usage, and level of satisfaction.

Even though the above description features a single survey, one should understand that such the user device 20 may detect fulfillment of survey trigger conditions at different moment during its useful life. The conditions triggering surveys may vary in relation with one survey to the other. Accordingly a specific-purpose user device 20 manufacturer may determine that collecting participations to a survey many times may better respond to objectives. Furthermore, software update and parameter update solutions may be used during the life of the user device 20 to change configurations, algorithm, components, database and parameters to reflect changes in objectives associated with the surveys. Therefore, survey may be triggered by the reception of a signal from the behavioral monitoring component, or new trigger conditions may be set triggering participation in a survey that would not have taken place without the update.

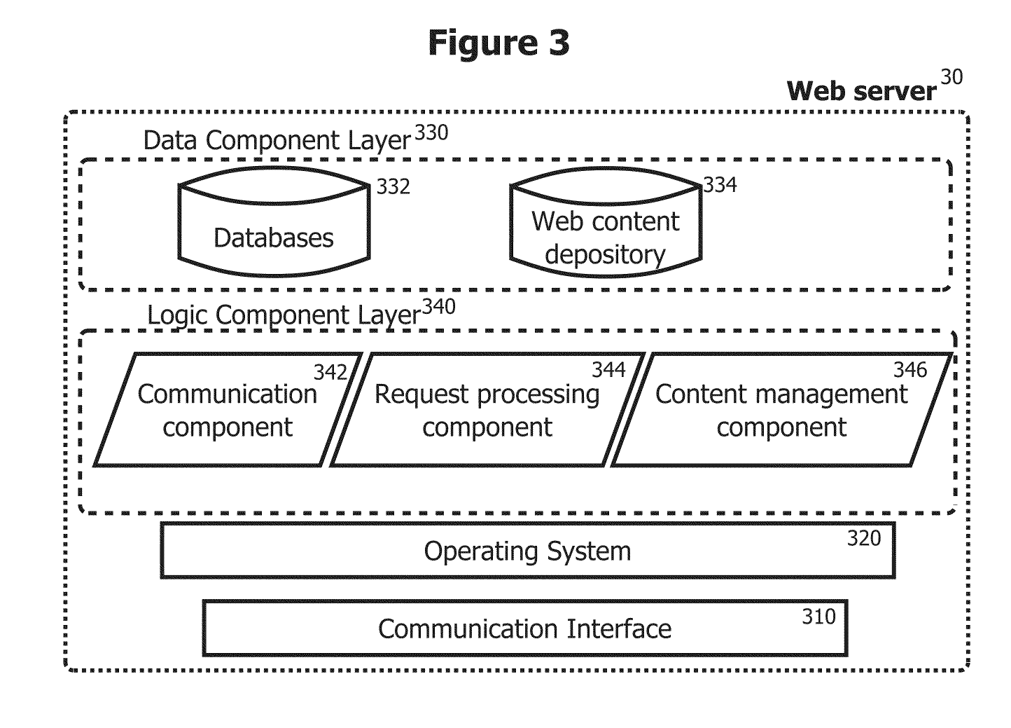

Reference is now made to FIG. 3 which schematically depicts the web server 30. The web server 30 comprises a communication interface 310, an operating system 320, and memory storing code conceivable as a data component layer 330 (dedicated to data storage) and a logic component layer 340 (dedicated to processes). It comprises among its process-dedicated components a communication component 342 controlling the communications with other processor-based devices, a request processing component 344 handling the processes associated with website visit and other communications with remote processor-based devices and a content management component 346 (also called Web Content Manager—WCM) adapted to generate website visit content. Also present in the data component layer 330 are databases 332 wherein data and parameters are stored, and a web content depository 334 wherein web content is stored.

In the present context, the term “web server” is taken according to a broad definition, namely a processor-based device performing several functions such as responding to website visit requests, and providing HTML documents and other web content to requesting devices over a network such as the Internet. These processes may be executed by a plurality of devices completing altogether the functions of the described web server, or may involve additional functions while remaining within the broad definition of the term. Communication with the web server is typically performed according to a TCP/IP protocol, but is not limited to that protocol.

Similarly, the term “server” must be construed as a processor-based device in communication with other devices over the Internet and able to perform specialized tasks based on exchange of communication with remote processor-based devices over a network such as the Internet.

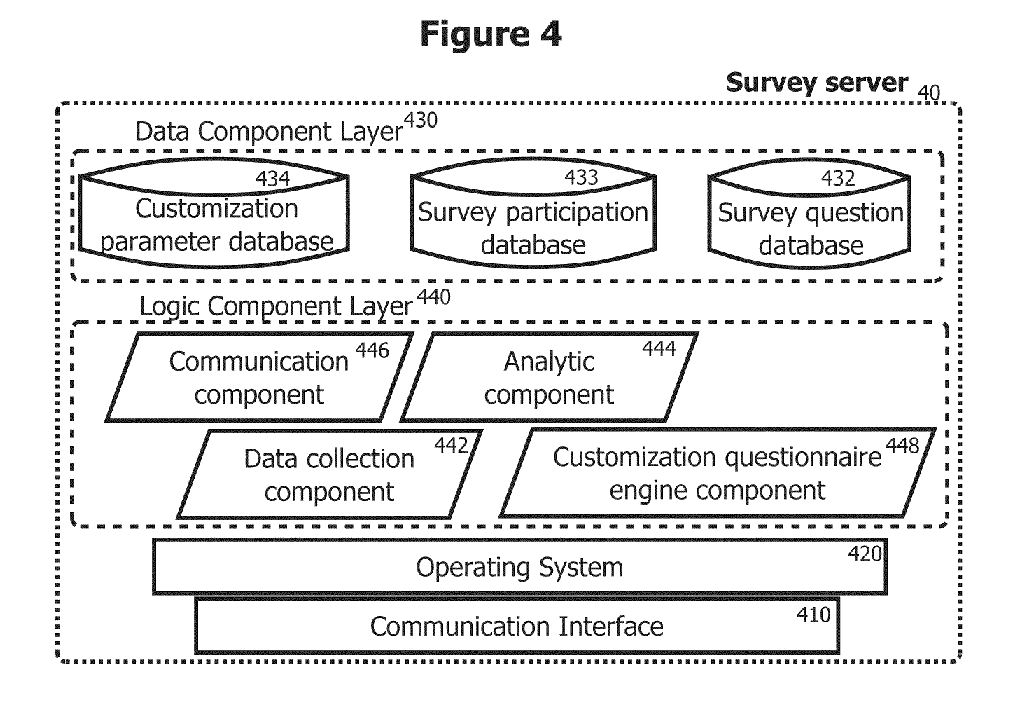

Reference is now made to FIG. 4. The survey server 40, interacting with the general-purpose user device 20 or the specific-purpose user device 20, comprises a communication interface 410, an operating system 420, and memory storing code corresponding to a data component layer 430 (dedicated to data storage) and a logic component layer 440 (dedicated to processes). The data component layer 430 is used to store the survey participation data (in a survey participation database 433), survey questions and survey question building data, for instance sentence models (in a survey question database 432) and, customization parameters used to generate customized survey questionnaires (in a customization parameter database 434). The logic component layer 440 comprises, once the instructions present in the code are executed, the following components: a data collection component 442 (survey collecting component) used to collect the survey participation data from web browsers and to store the survey data in the survey database 432, an analytic component 444 analysing the collected survey data to generate survey participation data and generate reports, a communication component 446 taking charge of communications, including exchange with web browsers and the transmission of the outcome generated by the analytic component to the web server, and a customizing questionnaire engine component 448 used to generate customized survey questionnaires.

According to an alternative, part of the survey building-related data (data contained in the survey question database 432 and customization parameter database 434) is transmitted at one point to the either the generic-purpose user device 20 or the specific-purpose user-device 20. The data stored on the survey server 40 is used as master data, used for communicating parameters, modifications, and other data that would be used by the survey conduct component 274 of the user device 20.

Accordingly, throughout the whole process, the survey server has two purposes with respect to the user devices 20: a) to transmit data used by the customizing questionnaire engine component 448 to generate a customized survey questionnaire, and b) to receive the participation data generated by the survey conduct component 274 of the generic-purpose user device 20 or the specific-purpose user-device 20.

Furthermore, the survey server 40 performs autonomous processes beforehand or after having received survey participation data. The final process consists in generating reports providing insight and comprehension of interaction with a website, usage of a specific-purpose user device 20 or the general level of satisfaction of the survey participant in relation with the user device 20, the website, specific functions of the user device 20, etc.

In the above alternatives, the format in which the survey questionnaire or the survey participation data is communicated can be any one of the following formats. According to an alternative, a question database comprises a table composed in a question in a first field, and a set of associated events in a second field. When generating the customized survey questionnaire, a virtual table is generated with a third flag field appended to the other two fields. For each question, when an event in listed in the executed behavioral data, the flag field is turn at positive. Once all questions are executed, all rows with no positive flag are erased from the virtual table. Therefore, at the end, only pertinent questions remain based on the transmitted behavioral data. Thereafter, a process is performed according to a survey algorithm to determine which, if not all, of the remaining questions of the virtual table are included in the customized survey questionnaire. Finally, a questionnaire file is generated in a XML format to be transmitted to the user device.

When receiving the survey participation data, the data is also transmitted in a XML format, both the questions and the provided answers included in the file. When the survey participant skipped questions, the XML file including indication of it, namely a “skipped” word. Once received, the survey participation data is executed so that the survey database include for each survey participation the list of all possible questions, a flag field associated with each question establishing if the question has been included or not in the customized survey questionnaire, and the associated response from the survey respondent for included questions, and an empty field for the others.

According to an alternative, a list of events used to determine the survey questions to include are integrated in a field for each survey participation.

According to an alternative, the survey server collects and store additional data in the survey database such as a session identifier, a browser type, screen definition information, a set of visited webpages, time of visit information, flag information for highly pertinent information on the survey respondent such as recurring flag for recurring survey respondent, purchase flag for survey respondent who performed a purchase during the browsing session in which the survey participation data has be provided, etc.

According to an alternative, the behavioral collecting component of the user device remains active during the participation to the survey, and collects information on events occurring on the user device when the survey responses are provided, such as times of response of the different questions, scrolling data informing if the display window has modified or not in order for the question to become visible to the survey participant, etc. Use of such information may, for instance, being used to evaluate automated responses.

According to an alternative, a survey communication language such as Triple-S XML is used to transmit the customized survey questionnaire to the user device, and to transmit the survey participation data to the survey server. Accordingly, easier transfer to a survey analytic server becomes possible. According to other alternatives, either Quantum or Snap languages are used to code the survey data.

Although the present method, user device and servers have been described in the foregoing description by way of the provided illustrative embodiments, these embodiments are not intended to limit the scope protection sought. Other embodiments could have been provided that would also have been within the limitations of the scope defined by the appended claims.

1. A method for generating and providing customized survey questionnaires on a processor-based user device, the method comprising:
monitoring, by a behavioral monitoring component on the user device, events occurring on the user device and generating behavioral data accordingly;
detecting, by the behavioral monitoring component, fulfillment of a survey trigger condition;
upon detection of the survey trigger condition fulfillment, generating, by a survey conduct component, a customized survey questionnaire including one of the following: a question either selected or generated based on the behavioral data;
providing, by a survey conduct component, the customized survey questionnaire to a user of the user device;
collecting, by the survey conduct component, a response to the question from the user, thereby generating survey participation data; and
transmitting, by the survey conduct component, the survey participation data to a survey server.

2. The method of claim 1, further comprising:
generating and transmitting, by a web client component, a website visit request or a webpage action signal to a web server;
receiving and processing, by the web client component, web content received in response to the website visit request or the webpage action signal;
displaying, by the web client component, webpages resulting from the executed web content; and
generating, by the web client component, an event to be monitored by the behavioral monitoring component according to an interaction occurring between the user and the user device for the displayed webpage.

3. The method of claim 2, further comprising receiving from a survey server survey conduct componentto be used by the survey conduct component when generating a customized survey questionnaire.

4. The method of claim 1, wherein providing to the user the customized survey questionnaire comprises one of:
displaying the customized survey questionnaire on a display component of the user device; and
establishing communication with a remotely networked device under control of the user which have display capability, and transmitting to the remotely networked device the customized survey questionnaire.

5. The method of claim 1, further comprising storing the behavioral data on memory of the processor-based user device.

6. A computer program product comprising a computer readable memory storing computer executable instructions thereon that when executed by a computer processor of a user device performs the method of claim 1.

7. A user device for generating and providing customized survey questionnaires, the user device comprising:
a processor;
a communication interface for communicating with a server through a communication network; and
memory storing data and instructions which, when executed generates the following components:
a behavioral monitoring component for monitoring events occurring on the user device and generating behavioral data accordingly, the behavioral monitoring component further detecting fulfillment of a survey trigger condition; and
a survey conduct component for generating a customized survey questionnaire, the customized survey questionnaire including a question either selected or generated based on the generated behavioral data using the survey customization data, the survey conduct component providing to a user the customized survey questionnaire, collecting a response to the question from the user thereby generating survey participation data, and transmitting the survey participation data to a survey server.

8. The user device of claim 7, wherein the memory storing data and instructions further generate when executed the following component:
a web client component for generating and transmitting website visit requests and webpage action signals to the web server, for receiving and processing web content received in response to the website visit requests and webpage action signals, for displaying webpages resulting from the processing the web content, and for generating events to be monitored by the behavioral monitoring component according to interactions between the user and the displayed webpage.
